(19) United States
(12) Patent Application Publication
(10) Pub. No.: US 2019/0392332 A1
(43) Pub. Date: Dec. 26, 2019

(54) Computer Program Stored in Computer Readable Medium and Database Server Transforming Decision Table Into Decision Tree

(71) Applicant: TMAXSOFT CO., LTD, Seongnam-si (KR)

(72) Inventor: Hoyeol Choi, Gyeonggi-do (KR)

(21) Appl. No.: 16/020,822

(22) Filed: Jun. 27, 2018

(30) Foreign Application Priority Data
Jun. 25, 2018 (KR) 10-2018-0072489

(51) Int. Cl. G06N 5/04; G06F 17/30

(52) U.S. Cl. CPC G06N 5/045; G06F 17/30569; G06F 17/30327

(57) ABSTRACT

Disclosed is a computer program stored in a computer readable storage medium in which the computer program includes commands which cause a computer to execute steps, the steps including: recognizing a first distinct value of each of a plurality of condition columns of a decision table; generating a first condition level of a decision tree by using a first condition column having the smallest first distinct value among the plurality of condition columns; creating a plurality of sub tables by combining the first condition column and each of remaining first condition columns other than the first condition column in the decision table; recognizing a second distinct value of each of the plurality of sub tables; recognizing a first sub table having the smallest second distinct value among the plurality of sub tables; and generating a second condition level of the decision tree by using a second condition column included in the first sub table among the plurality of condition columns included in the decision table.

### CROSS-REFERENCE TO RELATED APPLICATIONS

This application claims priority to and the benefit of Korean Patent Application No. 10-2018-0072489 filed in the Korean Intellectual Property Office on Jun. 25, 2018, the entire contents of which are incorporated herein by reference.

### TECHNICAL FIELD

The present disclosure relates to a database server and a computer program, and more particularly, to a database server and a computer program transforming a decision table into a minimized decision tree.

### BACKGROUND ART

Businesses of enterprises are rapidly expanding with explosive data growth and the emergence of diverse environments and platforms. As new business environments emerge, more efficient and flexible data services and information processing, and data management functions are needed. In response to these changes, a research is continued on databases to solve problems of high performance, high availability, and scalability which are foundations of corporate business implementation.

A database management system (DBMS) can store data files in respective disks. In addition, the DBMS can manage a disk space including the disks. Thus, the DBMS can enhance data integration and improve accessibility to data. Representative examples of the database management system include Tibero, Oracle, and IMS.

Meanwhile, the database server can transform a decision table into a decision tree and store the decision tree. Here, each condition row of the decision table may correspond to each condition level of the decision tree. Unlike the decision table, since the decision tree has predetermined directionality, it is important to decide an order of the condition level in configuring the decision tree. The reason is that the number of nodes included in the decision tree varies depending on which condition column of the decision table is designed at which condition level of the decision tree.

Therefore, development of a database server that minimizes the number of nodes when transforming the decision table into the decision tree is urgently required.

### SUMMARY OF THE INVENTION

The present disclosure has been made in an effort to provide a computer program stored in a computer readable storage medium and a database server transforming a decision table into a decision tree having minimum nodes.

However, technical objects of the present disclosure are not restricted to the technical object mentioned as above. Unmentioned technical objects will be apparently appreciated by those skilled in the art by referencing the following description.

An exemplary embodiment of the present disclosure provides a computer program stored in a computer readable storage medium in which the computer program includes commands which cause a computer to execute the following steps, the steps including: recognizing a first distinct value of each of a plurality of condition columns of a decision table; generating a first condition level of a decision tree by using a first condition column having the smallest first distinct value among the plurality of condition columns; creating a plurality of sub tables by combining the first condition column and each of remaining first condition columns other than the first condition column in the decision table; recognizing a second distinct value of each of the plurality of sub tables; recognizing a first sub table having the smallest second distinct value among the plurality of sub tables; and generating a second condition level of the decision tree by using a second condition column included in the first sub table among the plurality of condition columns included in the decision table.

Another exemplary embodiment of the present disclosure provides a database server including: a memory storing a decision table including a plurality of condition columns; a distinct value recognition unit recognizing a first distinct value of each of the plurality of condition columns of the decision table stored in the memory; and a decision tree creation unit generating a first condition level of a decision tree by using a first condition column having the smallest first distinct value among the plurality of condition columns.

Technical solving means which can be obtained in the present disclosure are not limited to the aforementioned solving means and other unmentioned solving means will be clearly understood by those skilled in the art from the following description.

According to some exemplary embodiments of the present disclosure, a decision table can be transformed into a decision tree having minimum nodes. Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a schematic view of a database management system according to some exemplary embodiments.

FIG. 2 is a block diagram for a database server according to some exemplary embodiments of the present disclosure.

FIG. 3 is a diagram for describing one example of a decision table stored in a memory of the database server according to some exemplary embodiments of the present disclosure.

FIG. 4 is a flowchart for describing a method for transforming a decision table into a decision tree in a database server according to some exemplary embodiments.

FIG. 5 is a diagram for describing a method for creating a plurality of sub tables in a database server according to some exemplary embodiments.

FIG. 6 is a diagram for describing one example of a method for creating a node included in a third condition level of a decision tree in a database server according to some exemplary embodiments.

FIG. 7 is a diagram illustrating one example of a decision tree created through a database server according to some exemplary embodiments.

FIG. 8 is a diagram for describing another example of a method for creating a third condition level of a decision tree in a database server according to some exemplary embodiments of the present disclosure.

FIG. 9 is a block diagram of a computing device according to an exemplary embodiment of the present disclosure.

### DETAILED DESCRIPTION

Advantages and features of the present disclosure, and methods for accomplishing the same will be more clearly understood from exemplary embodiments described in detail below with reference to the accompanying drawings. However, the present disclosure is not limited to the following exemplary embodiments but may be implemented in various different forms. The exemplary embodiments are provided only to make description of the present disclosure complete and to fully provide the scope of the present disclosure to a person having ordinary skill in the art to which the present disclosure pertains with the category of the invention, and the present disclosure will be defined by the appended claims. The size and relative size of the components marked in the drawings may be exaggerated for clarity of description. The size and relative size of the constituent elements marked in the drawings may be exaggerated for clarity of description. Like reference numerals refer to like components throughout the specification and “and/or” includes respective mentioned items and all one or more combinations of the items.

Hereinafter, like reference numerals refer to like or similar elements regardless of reference numerals and a duplicated description thereof will be omitted.

In describing an exemplary embodiment of the present disclosure, a detailed description of related known technologies will be omitted if it is determined that they make the gist of the exemplary embodiment of the present disclosure unclear. Further, the accompanying drawings are only for easily understanding the exemplary embodiment of the present disclosure and the technical spirit of the exemplary embodiment of the present disclosure is not limited by the accompanying drawings.

It is also to be understood that the terminology used herein is for the purpose of describing embodiments only and is not intended to limit the present disclosure. In this specification, singular forms include even plural forms unless the context clearly indicates otherwise. It is to be understood that the terms “comprise” and/or “comprising” used in the specification are intended to be inclusive in a manner that does not exclude the presence of stated components and does not exclude the addition.

Although the terms “first”, “second”, and the like are used for describing various components, these elements or components are not confined by these terms, of course. These terms are merely used for distinguishing one component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. It will be further understood that terms defined in commonly used dictionaries should not be interpreted in an idealized or excessive sense unless expressly and specifically defined.

Suffixes “module” and “unit” for components used in the following description are given or mixed in consideration of easy preparation of the specification only and do not have their own distinguished meanings or roles.

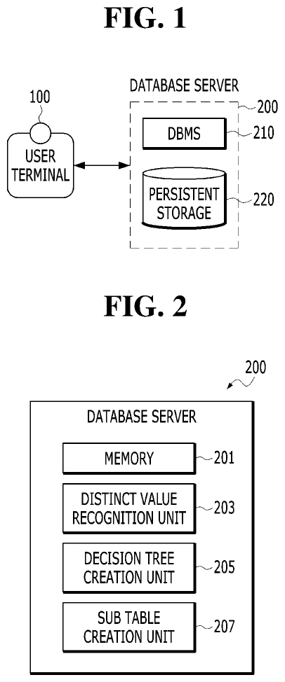

FIG. 1 is a schematic view of a database system according to some exemplary embodiments.

Referring to FIG. 1, the database system 1 may include a user terminal 100 and a database server 200. However, components described above are not required in implementing the database system 1 and the database system 1 may thus have components more or less than components listed above.

The user terminal 100 and the database server 200 may be connected to each other by a predetermined network (not illustrated).

The network presented herein may use various wired communication networks such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), etc.

The network presented in the present specification may use various wireless communication networks such as code division multi access (CDMA), time division multi access (TDMA), frequency division multi access (FDMA), orthogonal frequency division multi access (OFDMA), single carrier-FDMA (SC-FDMA), and other networks.

The network according to an aspect of the present disclosure may be configured regardless of communication modes such as wired and wireless modes and constituted by various networks including a personal area network (PAN), a local area network (LAN), a wide area network (WAN), and the like. Further, the network may be known World Wide Web (WWW) and may adopt a wireless transmission technology used for short-distance communication, such as infrared data association (IrDA) or Bluetooth.

A type of network is not limited to the example, but various communication systems may be included in the network.

The user terminal 100 may mean a node(s) in a database system 1 having a mechanism for communication through the network. For example, the user terminal 100 may include a predetermined electronic device having connectivity with a personal computer (PC), a laptop computer, a workstation, a terminal, and/or the network. Further, the user terminal 100 may include a predetermined server implemented by at least one of agent, application programming interface (API), and plug-in. In addition, the user terminal 100 may include an application source and/or a client application.

The user terminal 100 may be a predetermined entity which includes a processor and a memory to process and store predetermined data. Further, the user terminal 100 may be related with a user which uses the database server 200 or communicates with the database server 200. In such an example, the user terminal 100 may issue a query to the database server 200. In one example, the user terminal 100 may transfer a compiled and rewritten query to the database server 200. As one example, the user terminal 100 may receive the application source created by the programming language by the developer, etc. Further, for example, the user terminal 100 compiles the application source to create the client application. For example, the created client application may be transferred to the database server 200 and thereafter, optimized and executed.

The database server 200 may include a predetermined type of computer system or computer device such as a microprocessor, a mainframe computer, a digital processor, a portable device, and a device controller. The database server 200 may include a database management system (DBMS) 210 and a persistent storage 220. In FIG. 1, one database server and one user terminal are exemplarily illustrated, but it will be apparent to those skilled in the art that more database servers (management apparatuses) and user terminals therethan may also be included in the scope of the present disclosure.

Although not illustrated in FIG. 1, the database server 200 may include one or more memories including a buffer cache. Further, although not illustrated in FIG. 1, the database server 200 may include one or more processors. Therefore, the DBMS 210 may be operated by the processor on the memory.

Here, the memory as a primary storage device directly accessed by the processor, such as a random access memory (RAM) including a dynamic random access memory (DRAM), a static random access memory (SRAM), etc., may mean a volatile storage device in which stored information is momentarily erased when power is turned off, but is not limited thereto. The memory may be operated by control by the processor. The memory may temporarily store a data table including a data value. The data table may include the data value and in the exemplary embodiment of the present disclosure, the data value of the data table may be written in the persistent storage 220 from the memory. In an additional aspect, the memory may include the buffer cache and data may be stored in a data block of the buffer cache. The data may be written in the persistent storage 220 by a background process.

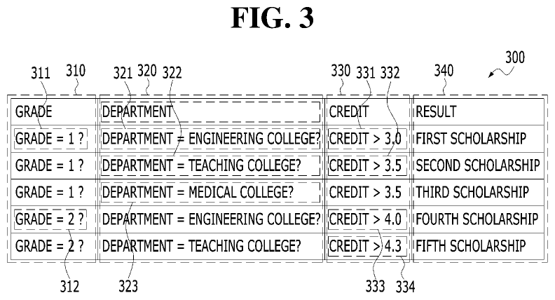

According to some exemplary embodiments, the memory may store a decision table including a plurality of condition columns. However, the database server 200 may convert the decision table including the plurality of condition columns stored in the memory into a decision tree including a plurality of condition levels and store the decision tree in the memory. A process of converting the decision table into the decision tree will be described in detail with reference to FIGS. 3 to 8.

The persistent storage 220 means a non-volatile storage medium which may consistently store predetermined data, such as a magnetic disk, an optical disk, and a magneto-optical storage device and a storage device based on a flash memory and/or a battery-backup memory. The persistent storage 220 may communicate with the processor and the memory of the database server 200 through various communication means. In an additional exemplary embodiment, the persistent storage 220 is positioned outside the database server 200 to communicate with the database server 200. Further, in FIG. 1, only one persistent storage and one DBMS are illustrated, but a type in which a plurality of DBMSs is connected to one persistent storage or a type including the plurality of persistent storages may also be included in the scope of the present disclosure.

The DBMS 210 as a program for permitting the database server 200 to perform operations including retrieval, insertion, modification, and/or deletion of required data may be implemented by the processor in the memory of the database server 200 as described above.

FIG. 2 is a block diagram for a database server according to some exemplary embodiments of the present disclosure. FIG. 3 is a diagram for describing one example of a decision table stored in a memory of the database server according to some exemplary embodiments of the present disclosure.

Referring to FIG. 2, a database server 200 may include a memory 201, a distinct value recognition unit 203, a decision tree generation unit 205, and a sub table creation unit 207. However, components described above are not required in implementing the database server 200 and the database server 200 may thus have components more or less than components listed above. Here, respective components may be configured as separate chips, modules, or devices and may be included in one device.

The memory 201 may store predetermined data stored in relation with execution of a task by the database server 200. The memory 201 may be included in the DBMS 210 and/or the persistent storage 220.

Additionally, the memory 201 may create a table and the like on the database serve 200. For example, the creation of the tables may be performed by a separate component such as a control module (not illustrated). Further, the memory 201 may process and manage a request related to the storing (including the update) of the data. The memory 201 may decide to store the data and the index table. Further, the memory 201 may decide a storage location for the data and/or the index table. For example, the memory 201 may decide the storage location of the data on the data table. As another example, the memory 201 may decide the storage location of the data on the persistent storage 220.

The memory 201 may store a decision table. Here, the decision table may include a plurality of condition columns and result columns. The condition column may mean a column including a condition among the plurality of columns included in the decision table and the result column may mean a column including a result among the plurality of columns included in the decision table.

For example, referring to FIG. 3, the decision table 300 stored in the memory 201 includes a grade condition column 310 including a plurality of conditions for a grade, a department condition column 320 including a plurality of conditions for a department, and a credit condition column 330 including a plurality of conditions for a credit.

The decision table 300 may include results provided when all conditions which exist in the same row in the decision table 300 are satisfied in the result column 340.

For example, when a condition 311 for confirming whether the grade is a first grade is satisfied in the grade condition column 310 existing in a first row of the decision table 300, a condition 321 for confirming whether the department is an engineering college in the department condition column 320 is satisfied in the department condition column 320, and a condition 331 for confirming whether the credit exceeds 3.0 is satisfied in the credit condition column 330, a result that a first scholarship is provided may be included in the first row of the result column 340.

Referring back to FIG. 2, the database server 200 may transform the decision table 300 stored in the memory 201 into the decision tree and store the decision tree in the memory 201. In this case, the number of nodes included in the decision tree may vary depending on which column of the decision table is designed at which condition level of the decision tree. If the number of nodes increases, efficiency of the decision tree may deteriorate, and as a result, the number of nodes needs to be minimized Accordingly, the database server 200 according to some exemplary embodiments may transform the decision table into a decision tree having minimum nodes by using a distinct value recognition unit 203, a decision tree creation unit 205, and a sub table creation unit 207.

The distinct value recognition unit 203 may recognize a distinct value of each of a plurality of condition columns of the decision table stored in the memory 201. Here, the distinct value of each of the plurality of condition columns may correspond to the number of conditions in which duplication is removed in each of the plurality of condition columns.

For example, referring back to FIG. 3, if the duplication of the conditions is removed in the grade condition column 310, the condition 311 for confirming whether the grade is the first grade and the condition 312 for confirming whether the grade is a second grade remain. Accordingly, the distinct value recognition unit 203 may recognize the distinct value of the grade condition column 310 of the decision table 300 as two.

When the duplication of the conditions is removed in the department condition column 320, the condition 321 for confirming whether the department is the engineering college, the condition 322 for confirming whether the department is a teaching college, and the condition 323 for confirming whether the department is a medical college remain. Accordingly, the distinct value recognition unit 203 may recognize the distinct value of the department condition column 320 of the decision table 300 as three.

When the duplication of the conditions is removed in the credit condition column 330, the condition 331 for confirming whether the credit exceeds 3.0, the condition 332 for confirming whether the credit exceeds 3.5, the condition 333 for confirming whether the credit exceeds 4.0, and the condition 334 for confirming whether the credit exceeds 4.3 remain. Accordingly, the distinct value recognition unit 203 may recognize the distinct value of the credit condition column 330 of the decision table 300 as four.

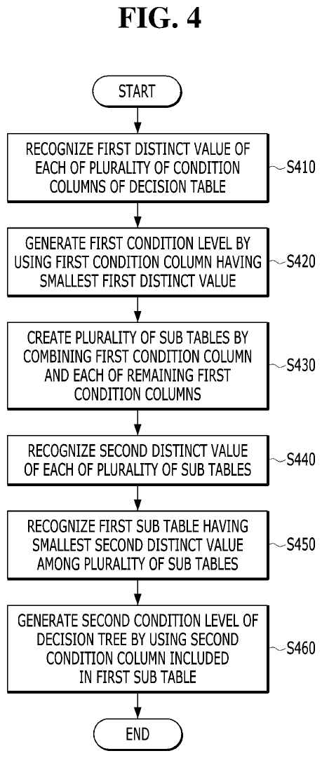

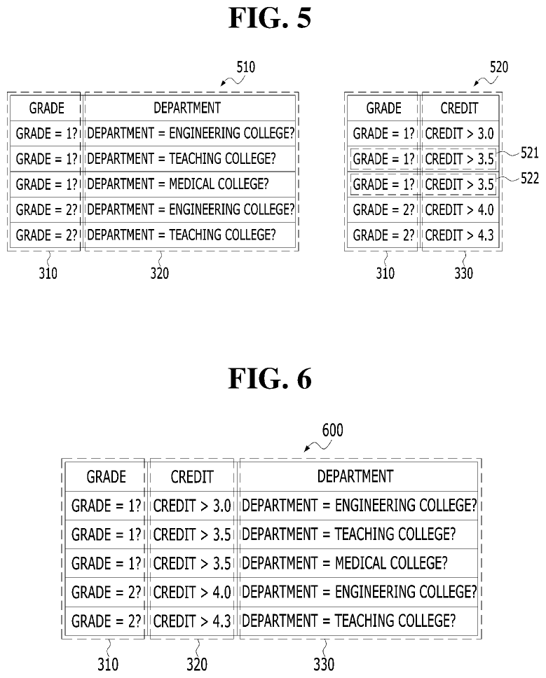

The distinct value recognition unit 203 may recognize the distinct value of each of a plurality of sub tables created through the sub table creation unit 207. Here, the distinct value of each of the plurality of sub tables may correspond to the number of rows in which the duplication is removed in each of the plurality of sub tables. The detailed description thereof will be described below in more detail with reference to FIGS. 4 and 5.

The decision tree creation unit 205 may generate each condition level included in the decision tree using the distinct value recognized through the distinct value recognition unit 203. For example, the decision tree creation unit 205 may generate a highest condition level of the decision tree using the first condition column having a smallest distinct value among the distinct values of the plurality of respective condition columns of the decision table. Further, the decision tree creation unit 205 may generate a second condition level of the decision tree by using a second condition column included in a sub table having the smallest distinct value among the plurality of sub tables created through the sub table creation unit 207. The detailed description thereof will be described below in more detail with reference to FIGS. 4 to 7.

The sub table creation unit 207 may create the sub table used when creating the decision tree. For example, the sub table creation unit 207 may create the plurality of sub tables by combining the first condition column having the smallest distinct value among the distinct values of the plurality of respective condition columns and respective remaining columns other than the first condition column among the plurality of condition columns. The detailed description thereof will be described below in more detail with reference to FIGS. 4 and 5.

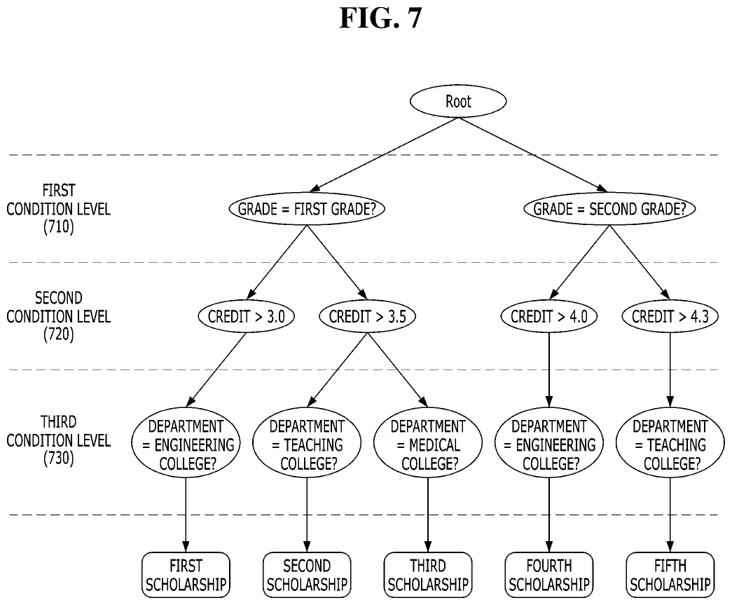

FIG. 4 is a flowchart for describing a method for transforming a decision table into a decision tree in a database server according to some exemplary embodiments. FIG. 5 is a diagram for describing a method for creating a plurality of sub tables in a database server according to some exemplary embodiments. FIG. 6 is a diagram for describing one example of a method for creating a node included in a third condition level of a decision tree in a database server according to some exemplary embodiments. FIG. 7 is a diagram illustrating one example of a decision tree created through a database server according to some exemplary embodiments. The contents with reference to FIGS. 4 to 7 overlapping with those described with reference to FIGS. 1 to 3 will not be described again, but the differences will be mainly described below.

Referring to FIG. 4, the distinct value recognition unit 203 may recognize a first distinct value of each of a plurality of condition columns of the decision table stored in the memory 201 (S410). Here, the first distinct value of each of the plurality of condition columns may correspond to the number of conditions in which duplication is removed in each of the plurality of condition columns. The detailed description thereof is described by referring back to FIG. 3.

Referring back to FIG. 3, when a decision table 300 includes a grade condition column 310 that includes a plurality of conditions for a grade, a department condition column 320 that includes a plurality of conditions for a department, and a credit condition column 330 including a plurality of conditions for a credit, the distinct value recognition unit 203 may recognize the first distinct value for each of the grade condition column 310, the department condition column 320, and the credit condition column 330.

Specifically, the distinct value recognition unit 203 may recognize the first distinct value corresponding to the number of conditions in which the duplication is removed in each of the grade condition column 310, the department condition column 320, and the credit condition column 330.

For example, when the duplication of the conditions is removed in the grade condition column 310, the condition 311 for confirming whether the grade is the first grade and the condition 312 for confirming whether the grade is the second grade remain. Accordingly, the distinct value recognition unit 203 may recognize the first distinct value of the grade condition column 310 of the decision table 300 as two.

When the duplication of the conditions is removed in the department condition column 320, the condition 321 for confirming whether the department is the engineering college, the condition 322 for confirming whether the department is a teaching college, and the condition 323 for confirming whether the department is a medical college remain. Accordingly, the distinct value recognition unit 203 may recognize the first distinct value of the department condition column 320 of the decision table 300 as three.

When the duplication of the conditions is removed in the credit condition column 330, the condition 331 for confirming whether the credit exceeds 3.0, the condition 332 for confirming whether the credit exceeds 3.5, the condition 333 for confirming whether the credit exceeds 4.0, and the condition 334 for confirming whether the credit exceeds 4.3 remain. Accordingly, the distinct value recognition unit 203 may recognize the first distinct value of the credit condition column 330 of the decision table 300 as four.

Referring back to FIG. 4, the decision tree creation unit 205 may generates the first condition level by using the first condition column having the smallest first distinct value among the first distinct values recognized in step S410 (S420).

Referring back to FIG. 3, since the first distinct value of the grade condition column 310 is the smallest as 2, the decision tree creation unit 205 may generate the first condition level using the grade condition column 310. Here, the first condition level may be a highest condition level of the decision tree.

A concrete method for creating the first condition level of the decision tree is described below.

Specifically, the decision tree creation unit 205 may create first nodes of a number at the first condition level, which is as large as the first distinct value of the first condition column having the smallest first distinct value among the plurality of condition columns included in the decision table. In addition, the decision tree creation unit 205 removes the duplication in the plurality of conditions included in the first condition column and arranges the conditions in the first node to generate the first condition level.

For example, referring to FIG. 7, the decision tree creation unit 205 may create nodes of a number as large as 2 which is the first distinct value of the grade condition column 310 having the smallest first distinct value in the decision table 300 of FIG. 3 at a first condition level 710 of the decision tree. That is, the decision tree creation unit 205 may create two nodes at the first condition level 710 which is the highest condition level. The decision tree creation unit 205 removes the duplication from the plurality of conditions of the grade condition column 310 included in the decision table 300 of FIG. 3 and arranges the condition 311 for confirming whether the grade is the first grade and the condition 312 for confirming whether the grade is the second grade in two nodes to create the first condition level 710.

Here, it may be assumed that there may be a plurality of (n) condition columns having the smallest distinct value. In this case, when two condition columns are selected among n condition columns to be made into one condition (for example, if the grade condition and the department condition have the same distinct value, a condition of grade AND department is made), n(n-1)/2 conditions are created and one of two condition columns constituting a condition having the smallest distinct value among the conditions may be decided as a predetermined first condition level.

Referring back to FIG. 4, after the first condition level 710 is generated in step S420, the sub table creation unit 207 may create the plurality of sub tables by combining the first condition column and each of the first remaining condition columns other than the first condition column in the decision table (S430).

For example, referring back to FIG. 3, the sub table creation unit 207 may create the sub table by combining the grade condition column 310 having the smallest first distinct value in the decision table 300 and each of the department condition column 320 and the credit condition column 330 other than the grade condition column 310 in the decision table. Specifically, referring to FIG. 5, the sub table creation unit 207 may create each of a sub table 510 in which the grade condition column 310 and the department condition column 320 are combined and a sub table 520 in which the grade condition column 310 and the credit condition column 330 are combined.

Referring back to FIG. 4, the decision tree creation unit 205 may recognize a second distinct value of each of the plurality of sub tables created in step S430 (S440). Here, the second distinct value of each of the plurality of sub tables may correspond to the number of rows in which the duplication is removed in each of the plurality of sub tables.

For example, referring to FIG. 5, since duplicated rows do not exist in a sub table 510 in which the grade condition column 310 and the department condition column 320 are combined, the decision tree creation unit 205 may recognize the second distinct value of the sub table 510 as 5 corresponding to the number of rows of the sub table 510. Meanwhile, referring to FIG. 4, since the second row 521 and the third row 522 are duplicated in a sub table 520 in which the grade condition column 310 and the credit condition column 330 are combined, the decision tree creation unit 205 may recognize the second distinct value of the sub table 520 as 4 which is the number of rows of the sub table 520 without duplication.

Referring back to FIG. 4, the decision tree creation unit 205 may recognize a first sub table having a smallest second distinct value among the plurality of sub tables by using the second distinct value of each of the plurality of sub tables recognized in step S430 (S450).

For example, referring to FIG. 5, the decision tree creation unit 205 may recognize that the second distinct value of the sub table 520 in which the grade condition column 310 and the credit condition column 330 are combined as 4 is smaller than 5 which is the second distinct value of the sub table 510 in which the grade condition column 310 and the department condition column 320 are combined. Accordingly, the decision tree creation unit 205 may recognize as the first sub table the sub table 520 in which the grade condition column 310 and the credit condition column 330 having the smallest second distinct value are combined among the plurality of sub tables 510 and 520.

Referring back to FIG. 4, the decision tree creation unit 205 generates a second condition level of the decision tree by using the second condition column included in the first sub table recognized in the step (S450) among the plurality of condition columns included in the first sub table (S460). Here, the second condition column may be a condition column different from the first condition column used when generating the first conditional level in step S420 among the condition columns included in the first sub table. In addition, when generating the second condition level, the decision tree creation unit 205 may cause the nodes including the conditions existing in the same row in the first sub-table to be connected to each other.

For example, referring back to FIG. 5, the decision tree creation unit 205 may generate the second condition level by using the grade condition column 310 and another credit condition column 330 used when the first condition level is generated in the sub table 520 which is the first sub table. Here, the second condition level may be a lower condition level of the first condition level which is the highest condition level of the decision tree.

A concrete method for generating the second condition level of the decision tree is described below.

Specifically, the decision tree creation unit 205 may create second nodes of a number at the second condition level, which is as large as the second distinct value of the sub table 520 of FIG. 5, which is the first sub table. In addition, the decision tree creation unit 205 removes the duplication in the plurality of conditions included in the credit condition column 330 other than the grade condition column 310 using the first condition level among the condition columns included in the sub table 520 and arranges the plurality of conditions without the duplication in the second node to generate the second condition level.

For example, referring to FIG. 7, the decision tree creation unit 205 may create nodes of a number as large as 4 which is the second distinct value of the sub table 520 which is the first sub table having the smallest second distinct value among the plurality of sub tables 510 and 520 of FIG. 5 at a second condition level 720 of the decision tree. That is, the decision tree creation unit 205 may create four nodes at the second condition level 720 which is a lower level of the highest condition level. Then, the decision tree creation unit 205 removes the duplication in a plurality of rows included in the sub-table 520 of FIG. 5 and arranges a condition 331 for confirming whether the credit exceeds 3.0 in two nodes connected with the node including the condition 311 for confirming whether the grade is the first grade and a condition 332 for confirming whether the grade exceeds 3.5 and arranges a condition 333 for confirming whether the credit exceeds 4.0 and a condition 334 for confirming whether the credit exceeds 4.3 in two nodes connected with the node including the condition 312 for confirming whether the grade is the second grade.

According to some exemplary embodiments, the sub table creation unit 207 may recognize the number of second remaining condition columns excluding the first condition column and the second condition column in the decision table after step S460 of FIG. 4. When a single number of second remaining condition column remains, the sub table creation unit 207 combines the second remaining condition columns with the first sub table to create a final sub table. The decision tree creation unit 205 may recognize the distinct value of the final sub table and then create third nodes of a number as large as the distinct value at a third condition level. In addition, the decision tree creation unit 205 removes the duplication in the plurality of conditions included in the second remaining condition columns and arranges the conditions without the duplication in the third node to generate the third condition level. Here, when generating the third condition level, the decision tree creation unit 205 may cause nodes including conditions existing just next to each other among the conditions existing in the same row in the final sub table to be connected to each other.

For example, the sub table creation unit 207 may recognize that the remaining condition columns excluding the grade condition column 310 and the credit condition column 330 used when the decision tree is generated in the decision table 300 of FIG. 3 are the department condition column 320. In this case, the sub table creation unit 207 may create a final sub table (600 of FIG. 6) in which the department condition column 320 is combined with the sub table 520 in which the grade condition column 310 and the credit condition column 330 of FIG. 5 are combined. The decision tree creation unit 205 may recognize a distinct value of the final sub table (600 of FIG. 6), i.e., a value corresponding to the number of rows in which the duplication is removed in the final sub table (600 in FIG. 6). Since there is no duplicated row in the final sub table (600 in FIG. 6), the distinct value may be 5. In addition, the decision tree creation unit 205 may create third nodes of a number at the third condition level (730 of FIG. 7), which is as large as 5 which is the distinct value. In addition, the decision tree creation unit 205 arranges the plurality of conditions included in the department condition column 330 in the third node to generate the third condition level (730 of FIG. 7). Here, the decision tree creation unit 205 may cause nodes including conditions existing just next to each other among the conditions existing in the same row in the final sub table 600 to be connected to each other.

For example, referring to FIG. 6, a condition for confirming whether the credit is 3.0 or higher and a condition for confirming whether the department is the engineering college exist in the same row in the final sub table 600 and exist immediately next to each other. Accordingly, referring to FIG. 7, the decision tree creation unit 205 may connect a node including the condition for confirming whether the department is the engineering college to a node including the condition for confirming whether the credit is 3.0 or higher.

Referring to FIG. 6, the condition for confirming whether the credit is 3.5 or higher and the condition for confirming whether the department is the teaching college exist in the same row in the final sub table 600 and exist immediately next to each other. Accordingly, referring to FIG. 7, the decision tree creation unit 205 may connect a node including the condition for confirming whether the department is the teaching college to a node including the condition for confirming whether the credit is 3.5 or higher.

Referring to FIG. 6, the condition for confirming whether the credit is 3.5 or higher and the condition for confirming whether the department is the medical college exist in the same row in the final sub table 600 and exist immediately next to each other. Accordingly, referring to FIG. 7, the decision tree creation unit 205 may connect a node including the condition for confirming whether the department is the medical college to a node including the condition for confirming whether the credit is 3.5 or higher.

Referring to FIG. 6, the condition for confirming whether the credit is 4.0 or higher and the condition for confirming whether the department is the engineering college exist in the same row in the final sub table 600 and exist immediately next to each other. Accordingly, referring to FIG. 7, the decision tree creation unit 205 may connect a node including the condition for confirming whether the department is the engineering college to a node including the condition for confirming whether the credit is 4.0 or higher.

Referring to FIG. 6, the condition for confirming whether the credit is 4.3 or higher and the condition for confirming whether the department is the teaching college exist in the same row in the final sub table 600 and exist immediately next to each other. Accordingly, referring to FIG. 7, the decision tree creation unit 205 may connect a node including the condition for confirming whether the department is the teaching college to a node including the condition for confirming whether the credit is 4.3 or higher.

Referring to FIG. 7, the decision tree creation unit 205 may generate the third condition level 730 and then generate a lowest level using the result column (340 in FIG. 3) of the decision table (300 in FIG. 3). In this case, the decision tree creation unit 205 may generate the lowest level to indicate that the corresponding result may be obtained when all of the conditions in the same row are satisfied in the decision table (300 in FIG. 3).

For example, referring to FIG. 3, when a condition 311 for confirming whether the grade is a first grade is satisfied, a condition 321 for confirming whether the department is an engineering college in the department condition column 320 is satisfied in the department condition column 320, and a condition 331 for confirming whether the credit exceeds 3.0 is satisfied in the credit condition column 330, it can be seen that the result that the first scholarship is provided is obtained. Therefore, in the case of the lowest level of FIG. 7, when the condition for confirming whether the grade is the first grade is satisfied at the first condition level 710, the condition for confirming whether the grade is higher than 3.0 at the second condition level 720 is satisfied, and the condition for confirming whether the department is the engineering college at the third conditional level 730 is satisfied, the nodes may be concatenated to obtain the result that the first scholarship is provided. By such a method, the nodes included in the lowest level may created and the result may be placed in each of the nodes.

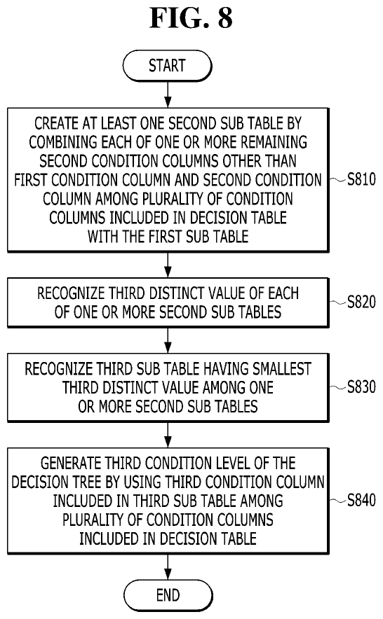

Meanwhile, according to some other exemplary embodiments, the sub table creation unit 207 may generate the third condition level by a method different from the above method when the number of second remaining condition columns excluding the first condition column and the second condition column in the decision table after step S460 of FIG. 4 is plural. This will be described below in more detail with reference to FIG. 8.

FIG. 8 is a diagram for describing another example of a method for creating a third condition level of a decision tree in a database server according to some exemplary embodiments of the present disclosure. The contents with reference to FIG. 8 overlapping with those described with reference to FIGS. 1 to 7 will not be described again, but the differences will be mainly described below.

First, when the number of second remaining condition columns excluding the first condition column and the second condition column in the decision table after step S460 of FIG. 4 is plural, the sub table creation unit 207 combines each of a plurality of remaining second condition columns other than the first condition column used when generating the first condition level and the second condition column used when generating the second condition level among the plurality of condition columns included in the decision table with the first sub table to create one or more second sub tables (S810). In this regard, the detailed contents are similar to those described in FIGS. 4 to 7, so that a detailed description will be omitted.

The distinct value recognition unit 203 may recognize the third distinct value of each of the one or more second sub tables (S820). Here, the third distinct value may correspond to the number of rows in which the duplication is removed in each of the one or more second sub tables. In this regard, the detailed contents are similar to those described in FIGS. 4 to 7, so that a detailed description will be omitted.

The decision tree creation unit 205 may recognize the third sub table having the smallest third distinct value among one or more second sub tables (S830). In addition, the decision tree creation unit 205 may generate the third condition level of the decision tree using the third condition column included in the third sub table among the plurality of condition columns included in the decision table. Here, the third condition column may be a condition column remaining after excluding the condition column included in the first sub table among the condition columns included in the third sub table and the third condition level may be a lower condition level of the second condition level. In this regard, the detailed contents are similar to those described in FIGS. 4 to 7, so that a detailed description will be omitted.

According to at least one of the above-described exemplary embodiments, the database server 200 may transform the decision table into a decision tree having a minimum number of nodes by minimizing duplication by raising a condition column having a large number of common attributes to a high level of the decision tree and may enhance efficiency of decision making Further, when the nodes of the decision tree are minimized, memory resources of the database server may be efficiently used, and a speed of the database server as a computing device may be enhanced. In addition, according to at least one of the above-described exemplary embodiments, the nodes of the decision tree may be minimized and stored, so that the storage space may be efficiently managed and more data may be stored in the database server as the computing device.

FIG. 9 is a block diagram of a computing device according to an exemplary embodiment of the present disclosure.

FIG. 9 illustrates a simple and general schematic view of an exemplary computing environment in which the exemplary embodiments of the present disclosure may be implemented.

Some exemplary embodiments of the present disclosure may be implemented by a computer executable command which may be executed on one or more computers, but it will be well appreciated by those skilled in the art that some exemplary embodiments of the present disclosure can be implemented through a combination with other program modules and/or a combination of hardware and software. According to some exemplary embodiments of the present disclosure, the database server 200 may be a computer.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As not a limit but an example, the computer readable media may include both computer readable storage media and computer readable transmission media. The computer readable storage media include volatile and non-volatile media, temporary or non-temporary media, and movable and non-movable media implemented by a predetermined method or technology for storing information such as a computer readable command, a data structure, a program module, or other data. The computer storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of anymedia among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor or other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable command, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in various operating systems which are commercially usable or a combination of the operating systems.

A user may input commands and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and a Bluetooth wireless technology. Accordingly, communication may be a predefined structure like the network in the related art or just ad hoc communication between at least two devices.

The Wi-Fi enables connection to the Internet, and the like without a wired cable. The Wi-Fi is a wireless technology such as a device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example,at a data rate of 11 Mbps(802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes a computer program, a carrier, or a medium which is accessible by a predetermined computer-readable device. Herein, the media may include storage media and transmission media. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information. Further, the transmission media include a wireless channel and various other media which are capable of transferring a command(s) and/or data, but are not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be analyzed within the widest range which is consistent with the principles and new features presented herein.

What is claimed is:

1. A computer program stored in a computer readable storage medium, wherein the computer program includes commands which cause a computer to execute steps, the steps comprising:
recognizing a first distinct value of each of a plurality of condition columns of a decision table;
generating a first condition level of a decision tree by using a first condition column having the smallest first distinct value among the plurality of condition columns;
creating a plurality of sub tables by combining the first condition column and each of remaining first condition columns other than the first condition column in the decision table;
recognizing a second distinct value of each of the plurality of sub tables;
recognizing a first sub table having the smallest second distinct value among the plurality of sub tables; and
generating a second condition level of the decision tree by using a second condition column included in the first sub table among the plurality of condition columns included in the decision table.

2. The computer program of claim 1, wherein the steps further comprise:
creating at least one second sub table by combining each of one or more remaining second condition columns other than the first condition column and the second condition column among the plurality of condition columns included in the decision table with the first sub table;
recognizing a third distinct value of each of the one or more second sub tables;
recognizing a third sub table having the smallest third distinct value among the one or more second sub tables; and
generating a third condition level of the decision tree by using a third condition column included in the third sub table among the plurality of condition columns included in the decision table.

3. The computer program of claim 1, wherein the first distinct value of each of the plurality of condition columns corresponds to the number of conditions in which duplication is removed in each of the plurality of condition columns.

4. The computer program of claim 1, wherein the first condition level is a highest condition level of the decision tree, and
the second condition level is a lowest condition level of the first condition level.

5. The computer program of claim 1, wherein the generating of the first condition level includes
creating first nodes of a number at the first condition level, which is as large as the first distinct value of the first condition columns, and
removing duplication in the plurality of conditions included in the first condition column and arranging the conditions without the duplication in the first node to generate the first condition level.

6. The computer program of claim 1, wherein the second distinct value of each of the plurality of sub tables corresponds to the number of rows in which the duplication is removed in each of the plurality of sub tables.

7. The computer program of claim 1, wherein the generating of the second condition level includes
creating second nodes of a number at the second condition level, which is as large as the second distinct value of the first sub table, and
arranging the plurality of conditions included in the second condition column in the second node to generate the second condition level.

8. The computer program of claim 2, wherein the third distinct value of each of the one or more second sub tables corresponds to the number of rows in which the duplication is removed in each of the one or more second sub tables.

9. The computer program of claim 2, wherein the third condition level is the lower condition level of the second condition level.

10. The computer program of claim 2, wherein the generating of the third condition level includes
creating third nodes of a number at the third condition level, which is as large as the third distinct value of the second sub table, and
arranging the plurality of conditions included in the third condition column in the third node to generate the third condition level.

11. A database server comprising:
a memory storing a decision table including a plurality of condition columns;
a distinct value recognition unit recognizing a first distinct value of each of the plurality of condition columns of the decision table stored in the memory; and
a decision tree creation unit generating a first condition level of a decision tree by using a first condition column having the smallest first distinct value among the plurality of condition columns

12. The database server of claim 11, further comprising:
a sub table creation unit creating a plurality of sub tables by combining the first condition column and each of remaining first condition columns other than the first condition column in the decision table,
wherein the distinct value recognition unit recognizes a second distinct value of each of the plurality of sub tables, and
the decision tree creation unit recognizes a first sub table having the smallest second distinct value among the plurality of sub tables and generates a second condition level of the decision tree by using a second condition column included in the first sub table among the plurality of condition columns included in the decision table.

13. The database server of claim 12, wherein the sub table creation unit creates one or more second sub tables by combining each of one or more remaining second condition columns other than the first condition column and the second condition column among the plurality of condition columns included in the decision table with the first sub table,
the distinct value recognition unit recognizes a third distinct value of each of the one or more second sub tables, and
the decision tree creation unit recognizes a third sub table having the smallest third distinct value among the one or more second sub tables and generates a third condition level of the decision tree by using a third condition column included in the third sub table among the plurality of condition columns included in the decision table.
